(19) United States
(12) Patent Application Publication
(10) Pub. No.: US 2025/0375891 A1
(43) Pub. Date: Dec. 11, 2025

(54) CONSTRUCTION METHOD AND SYSTEM FOR REAL-TIME TELEOPERATION OF DUAL ARM AND HAND ROBOT BASED ON VISION GUIDANCE

(71) Applicant: Yanshan University, Qinhuangdao (CN)

(72) Inventors: Guilin WEN, Qinhuangdao (CN); Xu SONG, Qinhuangdao (CN); Yahui ZHANG, Qinhuangdao (CN); Bingqin REN, Qinhuangdao (CN); Yingbing SUN, Qinhuangdao (CN); Hailin XU, Qinhuangdao (CN); Hao LU, Qinhuangdao (CN); Jialong ZHANG, Qinhuangdao (CN); Chen WANG, Qinhuangdao (CN); Zhao TAN, Qinhuangdao (CN); Guicheng LI, Qinhuangdao (CN); Yang TIAN, Qinhuangdao (CN)

(21) Appl. No.: 19/231,655

(22) Filed: Jun. 9, 2025

(30) Foreign Application Priority Data
Jun. 11, 2024 (CN) 2024107474905

(51) Int. Cl. B25J 9/16

(52) U.S. Cl. CPC B25J 9/1697; B25J 9/1689; B25J 9/1692

(57) ABSTRACT

The present invention relates to the field of robotic arm teleoperation technology, and specifically to a construction method and system for real-time teleoperation of a dual arm and hand robot based on vision guidance, which includes setting up a first experimental platform, acquiring pose information of the dual arm and hand robot and a homogeneous transformation matrix of an end joint and transforming a first coordinate system; setting up a second experimental platform; performing calibration by a plurality of cameras and transforming a second coordinate system; obtaining spatial transformation pose information of the end joint of the robotic arm under a tracking state, reading finger pose data, and performing real-time following. The real-time teleoperation system of the present disclosure includes a control system host, an operation glove, an optical locator, a positioning coordinate plate, a marker ball tool, and a dual arm and hand robot. The present disclosure introduces a method of identifying the marker ball tool by the optical locator into the teleoperation control of the dual arm and hand robot, which is more accurate and faster. Meanwhile, the method of remotely controlling the robotic arm by an operator wearing the operation gloves can provide better human-machine interaction function.

### TECHNICAL FIELD

The present disclosure belongs to the field of robotic arm teleoperation technology, and specifically relates to a construction method and system for real-time teleoperation of a dual arm and hand robot based on vision guidance.

### BACKGROUND

Vision servo is a commonly used environmental sensing method in the field of a robot. This technology refers to a ability of the robot to obtain image information of complex external environments through visual sensors, thereby assisting the robot in hand-eye coordinated motion control. A mounting positions between a visual camera and a robotic arm is divided into two types: one is eye-in-hand, where the vision system moves synchronously with the robotic arm; the other is eye-not-in-hand, where the relative position between the vision system and a base of the robotic arm keeps unchanged. The vision system transmits a difference signal between a target pose and a current pose of the robot to a controller of the robot, thereby driving the robot to complete hand-eye coordinated tasks.

With the rapid development of robot technology, teleoperation technology has been widely applied in the field of robot system control. Among the control methods of teleoperation systems, kinematic mapping of the pose is an important technology for realizing remote teleoperation of the robotic arms. The precise trajectory for the spatial motion of the robotic arm is controlled by a manipulator or a controller, and a mapping method in the Cartesian space has been widely used in teleoperation tasks. At present, how to realize human-like human-machine interaction functions has become a popular development direction for teleoperation systems in the future.

The teleoperation system realizes remote control by obtaining the operator's intention and converting it into control signals transmitted to the robot. Traditional interaction devices for obtaining the operator's intention include remote controllers, joysticks, keyboards, etc. However, these interaction devices cannot intuitively convert the operator's intention into robot actions, and the operation is cumbersome and difficult to understand.

### SUMMARY

In view of the above circumstances, the present disclosure provides a construction method and system for real-time teleoperation of a dual arm and hand robot based on vision guidance. Compared with traditional image detection methods for calculating spatial transformation pose based on texture or shape, a method of calculating spatial transformation pose using infrared positioning technology is more accurate, flexible, and rapid. Spatial pose transformation equations are provided by using an optical locator to identify position information of reflective marker balls to obtain a target pose information of the dual arm and hand robot. A finger pose information of the human-like robotic hand may be obtained by reading the finger position information from the operation glove. Thus, the remote control task of the dual arm and hand robot can be accomplished through an accurate and flexible human-machine interaction method.

The technical solution as employed by the present disclosure is to provide a construction method for real-time teleoperation of a dual arm and hand robot based on vision guidance, including following steps:
S1: setting up a first experimental platform: operating a dual arm and hand robot, a first optical locator, and a first positioning coordinate plate on the first experimental platform;
S2: acquiring a pose information of the dual arm and hand robot: identifying spatial coordinate information of a sixth marker ball tool and a seventh marker ball tool on a back of a hand of the dual arm and hand robot by the first optical locator to obtain the spatial pose information of the dual arm and hand robot, and obtaining a homogeneous transformation matrix

$${}_{camera 1}^{lhand} H$$

of the coordinate system of the first optical locator in a coordinate system of the first robotic hand, a homogeneous transformation matrix

$${}_{camera 1}^{rhand} H$$

of the coordinate system of the first optical locator in a coordinate system of the second robotic hand, and a homogeneous transformation matrix

$${}_{camera 1}^{board 1} H$$

of the coordinate system of the first optical locator in a coordinate system of the first positioning coordinate plate, and transmitting data to a control system host;
S3: acquiring a homogeneous transformation matrix of an end joint of the dual arm and hand robot: obtaining a homogeneous transformation matrix

$${}_{lend}^{lbase} H$$

of a coordinate system of the end joint of the first robotic arm in the coordinate system of the first robotic arm, and a homogeneous transformation matrix

$${}_{rend}^{rbase} H$$

of a coordinate system of the end joint of the second robotic arm in the coordinate system of the second robotic arm through a robotic arm interface function;
S4: transforming a first coordinate system: after hand-eye calibration algorithm and spatial pose transformation, obtaining a transformation matrix

$${}_{board 1}^{lbase} H$$

of the coordinate system of the first positioning coordinate plate in the coordinate system of the first robotic arm and a transformation matrix

$${}_{board 1}^{rbase} H$$

of the coordinate system of the first positioning coordinate plate in the coordinate system of the second robotic arm, and saving a calibration result in the control system host in a form of a text file;
S5: setting up a second experimental platform: operating a first operation glove, a second operation glove, a first optical locator, a second optical locator, and a second positioning coordinate plate on the second experimental platform;
S6: performing calibration by a plurality of cameras: placing a calibration tool provided with marker ball tools within a common viewing field of the first optical locator and the second optical locator, and determining relative pose relationship

$${}_{camera 2}^{camera 1} H$$

of the first optical locator and the second optical locator by using the spatial pose transformation, and saving the calibration result in the control system host in the form of a text file;
S7: transforming the second coordinate system: identifying a homogeneous transformation matrix

$${}_{rglove}^{camera 1} H$$

of a coordinate system of the first operation glove in the coordinate system of the first optical locator and a homogeneous transformation matrix

$${}_{board 2}^{camera 1} H$$

of a coordinate system of the second positioning coordinate plate in the coordinate system of the first optical locator through the first optical locator, and identifying a homogeneous transformation matrix

$${}_{lglove}^{camera 2} H$$

of a coordinate system of the second operation glove in the coordinate system of the second optical locator through the second optical locator, and retrieving a relative pose calibration result

$${}_{camera 2}^{camera 1} H$$

of the first optical locator and the second optical locators in the step S6, and after matrix calculation, obtaining a homogeneous transformation matrix

$${}_{rglove}^{board 2} H$$

of the coordinate system of the first operation glove in the coordinate system of the second positioning coordinate plate and a homogeneous transformation matrix

$${}_{1 glove}^{board 2} H$$

of the coordinate system of the second operation glove in the coordinate system of the second positioning coordinate plate;
S8: when in a real-time teleoperation process, the homogeneous transformation matrix

$${}_{1 glove}^{board 2} H$$

of the second positioning coordinate plate and the homogeneous transformation matrix of the coordinate system of the first operation glove relative to the coordinate system

$${}_{rglove}^{board 2} H$$

of the second positioning coordinate plate are respectively equal to the homogeneous transformation matrix

$${}_{lhand}^{board 1} H$$

of the coordinate system of the first robotic hand relative to the coordinate system of the first positioning coordinate plate and the homogeneous transformation matrix

$${}_{rhand}^{board 1} H$$

of the coordinate system of the second robotic hand relative to the coordinate system of the first positioning coordinate plate, and after matrix calculation, obtaining a homogeneous transformation matrix

$${}_{lend}^{lbase} {H}_{aim}^{}$$

of the coordinate system of the end joint of the first robotic arm in the coordinate system of the first robotic arm and a homogeneous transformation matrix

$${}_{rend}^{rbase} {H}_{aim}^{{}_{}}$$

of the coordinate system of the end joint of the second robotic arm in the coordinate system of the second robotic arm under a tracking state;
S9: transmitting a finger pose data to the control system host after the finger pose data is read by a finger pose sensor in the first operation glove and the second operation glove;
S10: transmitting motion trajectory data of the first operation glove and the second operation glove relative to the second positioning coordinate plate collected by the first optical locator and the second optical locator to the control system host, and after being transformed into the pose transformation of the hands of the dual arm and hand robot relative to the first positioning coordinate plate, issuing control commands by the control system host to control the first robotic hand and first robotic arm and the second robotic hand and second robotic arm of the dual arm and hand robot to respectively perform real-time following of the transformed motion trajectory.

Preferably, spatial pose transformation equations for determining the relative pose relationship between the first robotic arm and the second robotic arm of the dual arm and hand robot and the first positioning coordinate plate through the first optical locator are

$${}_{board 1}^{lbase} H = {}_{camera 1}^{lbase} H \cdot {}_{board 1}^{camera 1} H and {}_{board 1}^{rbase} H = {}_{camera 1}^{rbase} H \cdot {}_{board 1}^{camera 1} H ,$$

wherein

$${}_{board 1}^{lbase} H$$

is the homogeneous transformation matrix of the coordinate system of the first positioning coordinate plate in the coordinate system of the first robotic arm,

$${}_{camera 1}^{lbase} H$$

is the homogeneous transformation matrix of the coordinate system of the first optical locator in the coordinate system of the first robotic arm,

$${}_{board 1}^{rbase} H$$

is the homogeneous transformation matrix of the coordinate system of the first positioning coordinate plate in the coordinate system of the first optical locator,

$${}_{camera 1}^{rbase} H$$

is the homogeneous transformation matrix of the coordinate system of the first positioning coordinate plate in the coordinate system of the second robotic arm, and

$${}_{camera 1}^{rbase} H$$

is the homogeneous transformation matrix of the coordinate system of the first optical locator in the coordinate system of the second robotic arm.

Preferably, the homogeneous transformation matrix of the coordinate system of the first operation glove in the coordinate system of the second positioning coordinate plate and the homogeneous transformation matrix of the coordinate system of the second operation glove in the coordinate system of the second positioning coordinate plate are obtained by using the matrix calculation equations

$${}_{rglove}^{board 2} H = {}_{camera 1}^{board 2} H \cdot {}_{rglove}^{camera 1} H and {}_{lglove}^{board 2} H = {}_{camera 1}^{board 2} H \cdot {}_{camera 2}^{camera 1} H \cdot {}_{lglove}^{camera 2} H ,$$

where

$${}_{camera 1}^{board 2} H$$

is the homogeneous transformation matrix of the coordinate system of the first optical locator in the coordinate system of the second positioning coordinate plate,

$${}_{rglove}^{camera 1} H$$

is the homogeneous transformation matrix of the coordinate system of the first operation glove in the coordinate system of the first optical locator,

$${}_{camera 1}^{board 2} H$$

is the homogeneous transformation matrix of the coordinate system of the first optical locator in the coordinate system of the second positioning coordinate plate,

$${}_{camera 2}^{camera 1} H$$

is the homogeneous transformation matrix of the coordinate system of the second optical locator in the coordinate system of the first optical locator, and

$${}_{lglove}^{camera 2} H$$

is the homogeneous transformation matrix of the coordinate system of the second operation glove in the coordinate system of the second optical locator.

Preferably, the relative poses of the coordinate system of the first robotic hand and the coordinate system of the second robotic hand of the dual arm and hand robot relative to the coordinate system of the first positioning coordinate plate are respectively equal to the relative poses of the coordinate system of the second operation glove and the coordinate system of the first operation glove relative to the coordinate system of the second positioning coordinate plate, that is,

$${}_{lhand}^{board 1} H = {}_{lglove}^{board 2} H$$

$$and$$

$${}_{rhand}^{board 1} H = {}_{rglove}^{board 2} H ,$$

and after matrix calculation,

$${}_{lend}^{lbase} {H}_{aim} = {}_{board 1}^{lbase} H \cdot {}_{lhand}^{board 1} H \cdot {}_{lend}^{lhand} H$$

$$and$$

$${}_{rend}^{rbase} {H}_{aim} = {}_{board 1}^{rbase} H \cdot {}_{rhand}^{board 1} H \cdot {}_{rend}^{rhand} H ,$$

the homogeneous transformation matrix

$${}_{lend}^{lbase} {H}_{aim}$$

of the coordinate system of the end joint of the first robotic arm in the coordinate system of the first robotic arm and the homogeneous transformation matrix

$${}_{rend}^{rbase} {H}_{aim}$$

of the coordinate system of the end joint of the second robotic arm in the coordinate system of the second robotic arm under the tracking state are obtained, wherein

$${}_{board 1}^{lbase} H$$

is the homogeneous transformation matrix of the coordinate system of the first positioning coordinate plate in the coordinate system of the first robotic arm,

$${}_{lhand}^{board 1} H$$

is the homogeneous transformation matrix of the coordinate system of the first robotic hand in the coordinate system of the first positioning coordinate plate,

$${}_{lend}^{lhand} H$$

is the homogeneous transformation matrix of the coordinate system of the end joint of the first robotic arm in the coordinate system of the first robotic hand,

$${}_{board 1}^{rbase} H$$

is the homogeneous transformation matrix of the coordinate system of the first positioning coordinate plate in the coordinate system of the second robotic arm,

$${}_{rhand}^{board 1} H$$

is the homogeneous transformation matrix of the coordinate system of the second robotic hand in the coordinate system of the first positioning coordinate plate, and

$${}_{rend}^{rhand} H$$

is the homogeneous transformation matrix of the coordinate system of the end joint of the second robotic arm in the coordinate system of the second robotic hand.

Preferably, a movement control command is issued to the dual arm and hand robot to achieve a real-time teleoperation task of the dual arm and hand robot by the operation glove, and the spatial pose transformation relationships on which the control command is based are

$${}_{lend}^{lbase} {H}_{aim} and {}_{rend}^{rbase} {H}_{aim} ,$$

wherein

$${}_{lend}^{lbase} {H}_{aim}$$

is the homogeneous transformation matrix of the coordinate system of the end joint of the first robotic arm in the coordinate system of the first robotic arm under the tracking state, and

$${}_{rend}^{rbase} {H}_{aim}$$

is the homogeneous transformation matrix of the coordinate system of the end joint of the second robotic arm in the coordinate system of the second robotic arm under the tracking state.

Preferably, the hand-eye calibration algorithm solving formulas are

$${}_{lend}^{lhand} H = {}_{camera 1}^{lhand} H \cdot {}_{lbase}^{camera 1} H \cdot {}_{lend}^{lbase} H$$

$$and$$

$${}_{rend}^{rhand} H = {}_{camera 1}^{rhand} H \cdot {}_{rbase}^{camera 1} H \cdot {}_{rend}^{rbase} H ,$$

wherein

$${}_{lend}^{lhand} H$$

is the homogeneous transformation matrix of the coordinate system of the end joint of the first robotic arm in the coordinate system of the first robotic hand,

$${}_{camera 1}^{lhand} H$$

is the homogeneous transformation matrix of the coordinate system of the first optical locator in the coordinate system of the first robotic hand,

$${}_{lbase}^{camera 1} H$$

is the homogeneous transformation matrix of the coordinate system of the first robotic arm in the coordinate system of the first optical locator,

$${}_{lend}^{lbase} H$$

is the homogeneous transformation matrix of the coordinate system of the end joint of the first robotic arm in the coordinate system of the first robotic arm,

$${}_{rend}^{rhand} H$$

is the homogeneous transformation matrix of the coordinate system of the end joint of the second robotic arm in the coordinate system of the second robotic hand,

$${}_{camera 1}^{rhand} H$$

is the homogeneous transformation matrix of the coordinate system of the first optical locator in the coordinate system of the second robotic hand,

$${}_{rbase}^{camera 1} H$$

is the homogeneous transformation matrix of the coordinate system of the second robotic arm in the coordinate system of the first optical locator, and

$${}_{rend}^{rbase} H$$

is the homogeneous transformation matrix of the coordinate system of the end joint of the second robotic arm in the coordinate system of the second robotic arm.

Preferably, the step S1 includes following sub-steps:
S11: placing the first optical locator in front of the dual arm and hand robot;
S12: placing the sixth marker ball tool and the seventh marker ball tool respectively in fixing devices on the backs of the hands of the dual arm and hand robot, and placing them within the common viewing field of the first optical locator;
S13: placing the first positioning coordinate plate in front of the dual arm and hand robot and providing a third marker ball tool on the first positioning coordinate plate within the common viewing field of the first optical locator.

Preferably, the step S5 includes following sub-steps:
S51: moving the first optical locator from the first experimental area to the second experimental area, and placing the first optical locator and the second optical locator in front of the first operation glove and the second operation glove, respectively;
S52: placing the first marker ball tool and the second marker ball tool in the fixing devices on the backs of the first operation glove and the second operation glove, respectively, and placing them within the common viewing field of the first optical locator and the second optical locator, respectively;
S53: placing the second positioning coordinate plate in front of the first operation glove and the second operation glove, within the common viewing field of the first optical locator.

According to a second aspect of the present disclosure, there is provided a real-time teleoperation system for a dual arm and hand robot based on vision guidance, including a control system host, a first operation glove, a second operation glove, a first optical locator, a second optical locator, a first positioning coordinate plate, a second positioning coordinate plate, a first marker ball tool, a second marker ball tool, a third marker ball tool, a fourth marker ball tool, a fifth marker ball tool, and a dual arm and hand robot;

wherein the control system host receives and processes finger pose information of the first operation glove and the second operation glove, connects with the dual arm and hand robot via Ethernet, and issues control commands; the first operation glove and the second operation glove are both provided with sensors and are worn by an operator; the first operation glove is provided with the first marker ball tool on the back thereof, and the second operation glove is provided with the second marker ball tool on the back thereof, the first positioning coordinate plate is provided with the third marker ball tool, and the second positioning coordinate plate is provided with the fourth marker ball tool; the first optical locator captures a coordinate information of the first marker ball tool, the second optical locator captures a coordinate information of the second marker ball tool, and the first optical locator also captures pose information of the third marker ball tool, the fourth marker ball tool, and the fifth marker ball tool simultaneously; the first optical locator and the second optical locator transmit all captured pose information and spatial coordinate data via the Ethernet to the control system host, the captured pose information and spatial coordinate data are processed uniformly by the control system host, and control commands are sent to the dual arm and hand robot; the dual arm and hand robot includes a first robotic arm, a second robotic arm, a first robotic hand, and a second robotic hand; and the first robotic hand is mounted on the first robotic arm, the second robotic hand is mounted on the second robotic arm, both the first robotic arm and the second robotic arm are six-axis robotic arms, the fifth marker ball tool includes a sixth marker ball tool and a seventh marker ball tool, and the sixth marker ball tool is fixed to the first robotic hand, and the seventh marker ball tool is fixed to the second robotic hand 84.

Compared with the prior art, the present disclosure has following advantages:
1. Compared with traditional image detection methods based on texture or shape, a calculation rate for identifying and locating the target pose information is higher, and the calculation accuracy is also higher.
2. The construction method of the teleoperation system for the dual arm and hand robot is simple.
3. The teleoperation human-machine interaction method is simpler, clearer, and more intuitive.
4. The dual arm and hand robot can flexibly and quickly imitate complex movements of the human's hands.

### BRIEF DESCRIPTION OF THE DRAWINGS

FIG. 1 is a flowchart of a construction method for a real-time teleoperation system of the present disclosure;

FIG. 2 is a flowchart of a construction method for a first experimental platform of the present disclosure;

FIG. 3 is a flowchart of a construction method for a second experimental platform of the present disclosure;

FIG. 4 is a schematic view of a structure of a teleoperation system for the dual arm and hand robot of the present disclosure;

FIG. 5 is a schematic view of a layout of the first experimental area of the present disclosure;

FIG. 6 is a schematic view of a layout of the second experimental area of the present disclosure.

### DETAILED DESCRIPTION

In order to elaborate on the technical content, structural features, objectives achieved, and the effectiveness of the present disclosure, the detailed description will be provided in conjunction with the accompanying drawings of the specification.

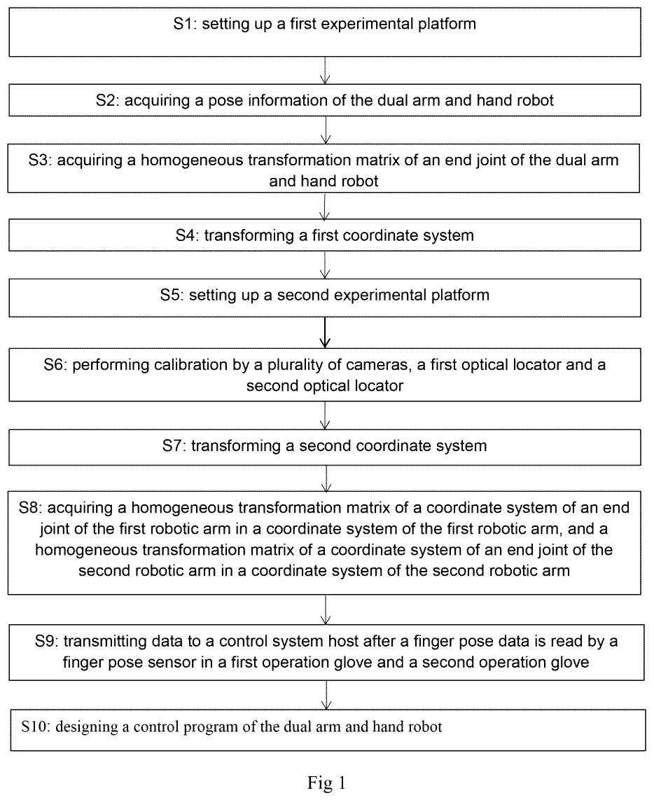

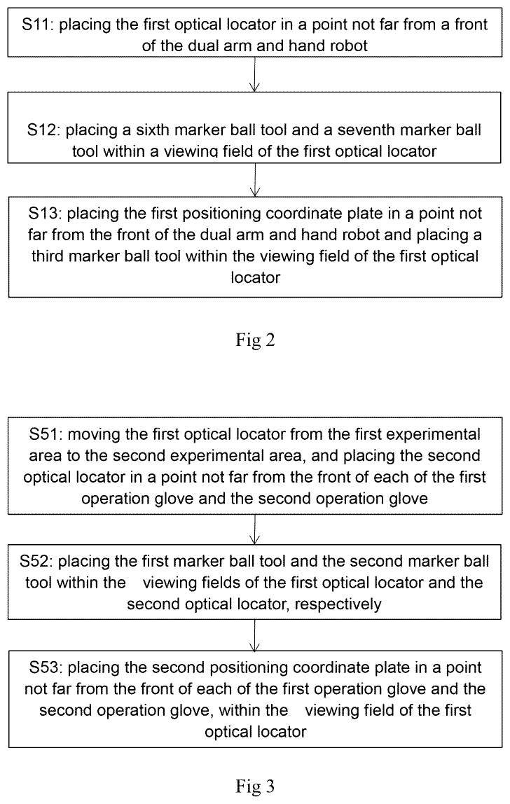

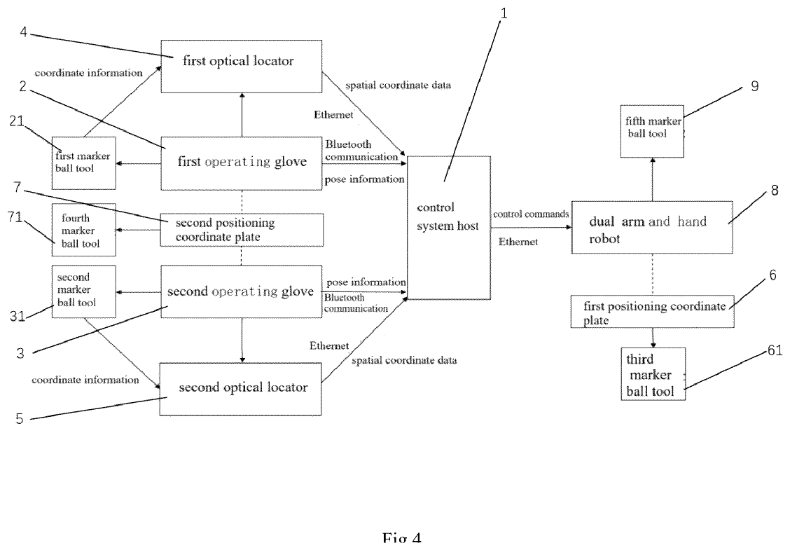

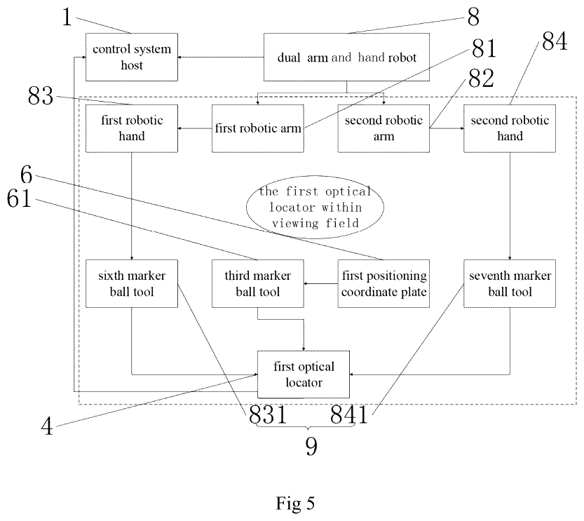

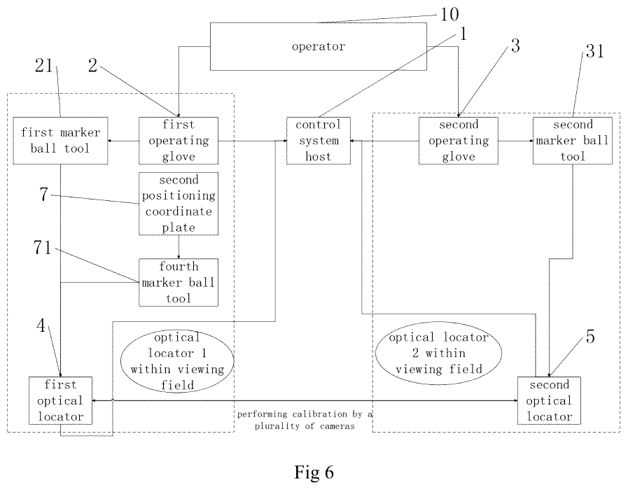

The present disclosure provides a construction method for real-time teleoperation of a dual arm and hand robot based on vision guidance. As shown in FIGS. 1-6, the construction method includes following steps:
S1: setting up a first experimental platform: operating a dual arm and hand robot 8, a first optical locator 4, and a first positioning coordinate plate 6 within the first experimental platform, including following sub-steps:
S11: placing the first optical locator 4 in front of the dual arm and hand robot 8;
S12: placing the sixth marker ball tool 831 and the seventh marker ball tool 841 respectively in fixing devices on the backs of the hands of the dual arm and hand robot 8, and placing them within the common viewing field of the first optical locator 4;
S13: placing the first positioning coordinate plate 6 in front of the dual arm and hand robot 8 and providing a third marker ball tool 61 on the first positioning coordinate plate 6 within the common viewing field of the first optical locator 4.
S2: acquiring a pose information of the dual arm and hand robot 8: identifying spatial coordinate information of a sixth marker ball tool 831 and a seventh marker ball tool 841 on the back of the hand of the dual arm and hand robot 8 by the first optical locator 4 to obtain the spatial pose information of the dual arm and hand robot 8, and obtaining a homogeneous transformation matrix

$${}_{camera 1}^{lhand} H$$

of a coordinate system of the first optical locator 4 in a coordinate system of a first robotic hand 83, a homogeneous transformation matrix

$${}_{camera 1}^{rhand} H$$

of the coordinate system of the first optical locator 4 in a coordinate system of the second robotic hand 84, and a homogeneous transformation matrix

$${}_{camera 1}^{board 1} H$$

of the coordinate system of the first optical locator 4 in a coordinate system of the first positioning coordinate plate 6, and transmitting data to a control system host 1;
S3: acquiring a homogeneous transformation matrix of an end joint of the dual arm and hand robot 8: obtaining a homogeneous transformation matrix

$${}_{lend}^{lbase} H$$

of a coordinate system of the end joint of a first robotic arm 81 in the coordinate system of the first robotic arm 81, and a homogeneous transformation matrix

$${}_{rend}^{rbase} H$$

of a coordinate system of the end joint of a second robotic arm 82 in the coordinate system of the second robotic arm 82 through a robotic arm interface function;
S4: transforming a first coordinate system: after hand-eye calibration algorithm and spatial pose transformation, obtaining a transformation matrix

$${}_{board 1}^{lbase} H$$

of the coordinate system of the first positioning coordinate plate 6 in the coordinate system of the first robotic arm 81 and a transformation matrix

$${}_{board 1}^{rbase} H$$

of the coordinate system of the first positioning coordinate plate 6 in the coordinate system of the second robotic arm 82, and saving a calibration result in the control system host 1 in a form of a text file;
S5: setting up a second experimental platform: operating a first operation glove 2, a second operation glove 3, a first optical locator 4, a second optical locator 5, and a second positioning coordinate plate 7 within the second experimental platform, specifically including following sub-steps:
S51: moving the first optical locator 4 from the first experimental area to the second experimental area, and placing the first optical locator 4 and the second optical locator 5 in front of the first operation glove 2 and the second operation glove 3, respectively;
S52: placing the first marker ball tool 21 and the second marker ball tool 31 in the fixing devices on the backs of the first operation glove 2 and the second operation glove 3, respectively, and placing them within the common viewing field of the first optical locator 4 and the second optical locator 5, respectively;
S53: placing the second positioning coordinate plate 7 in front of the first operation glove 2 and the second operation glove 3, within the common viewing field of the first optical locator 4.
S6: performing calibration by a plurality of cameras: placing a calibration tool provided with marker ball tools within a common viewing field of the first optical locator 4 and the second optical locator 5, and determining the relative pose relationship

$${}_{camera 2}^{camera 1} H$$

of the first optical locator 4 and the second optical locator 5 by using the spatial pose transformation, and saving the calibration result in the control system host 1 in the form of a text file;
S7: transforming the second coordinate system: identifying a homogeneous transformation matrix

$${}_{rglove}^{camera 1} H$$

of a coordinate system of the first operation glove 2 in the coordinate system of the first optical locator 4 and a homogeneous transformation matrix

$${}_{board 2}^{camera 1} H$$

of a coordinate system of the second positioning coordinate plate 7 in the coordinate system of the first optical locator 4 through the first optical locator 4, and identifying a homogeneous transformation matrix

$${}_{1 glove}^{camera 2} H$$

of a coordinate system of the second operation glove 3 in the coordinate system of the second optical locator 5 through the second optical locator 5, and retrieving a relative pose calibration result

$${}_{camera 2}^{camera 1} H$$

of the first optical locator 4 and the second optical locator 5 in the step S6, and after matrix calculation, obtaining a homogeneous transformation matrix

$${}_{rglove}^{board 2} H$$

of the coordinate system of the first operation glove 2 in the coordinate system of the second positioning coordinate plate 7 and a homogeneous transformation matrix

$${}_{1 glove}^{board 2} H$$

of the coordinate system of the second operation glove 3 in the coordinate system of the second positioning coordinate plate 7;
S8: when in a real-time teleoperation process, the homogeneous transformation matrix

$${}_{1 glove}^{board 2} H$$

of the coordinate system of the second operation glove 3 relative to the coordinate system of the second positioning coordinate plate 7 and the homogeneous transformation matrix

$${}_{rglove}^{board 2} H$$

of the coordinate system of the first operation glove 2 relative to the coordinate system of the second positioning coordinate plate 7 are respectively equal to the homogeneous transformation matrix

$${}_{lhand}^{board 1} H$$

of the coordinate system of the first robotic hand 83 relative to the coordinate system of the first positioning coordinate plate 6 and the homogeneous transformation matrix

$${}_{rhand}^{board 1} H$$

of the coordinate system of the second robotic hand 82 relative to the coordinate system of the first positioning coordinate plate 6, and after matrix calculation, obtaining a homogeneous transformation matrix

$${}_{lend}^{lbase} {H}_{aim}$$

of the coordinate system of the end joint of the first robotic arm 81 in the coordinate system of the first robotic arm 81 and a homogeneous transformation matrix

$${}_{rend}^{rbase} {H}_{aim}$$

of the coordinate system of the end joint of the second robotic arm 82 in the coordinate system of the second robotic arm 82 under a tracking state;
S9: transmitting data to the control system host in a manner of a bluetooth communication after the finger pose information is read by a finger pose sensor in the first operation glove 2 and the second operation glove 3;
S10: designing a control program of the dual arm and hand robot 8: reading the finger pose data of the first operation glove 2 and the second operation glove 3 and transmitting it to the control system host 1, and transmitting motion trajectory data of the first operation glove 2 and the second operation glove 3 relative to the second positioning coordinate plate 7 collected by the first optical locator 4 and the second optical locator 5 to the control system host 1, and after being transformed into the pose transformation of the hands of the dual arm and hand robot 8 relative to the first positioning coordinate plate 6, issuing control commands by the control system host 1 to control the first robotic hand 83 and first robotic arm 81 and the second robotic hand 84 and second robotic arm 82 of the dual arm and hand robot 8 to respectively perform real-time following of the transformed motion trajectory.

Spatial pose transformation equations for determining the relative pose relationship between the first robotic arm 81 and the second robotic arm 82 of the dual arm and hand robot 8 and the first positioning coordinate plate 6 through the first optical locator 4 are

$${}_{board 1}^{lbase} H = {}_{camera 1}^{lbase} H \cdot {}_{board 1}^{camera 1} H and {}_{board 1}^{rbase} H = {}_{camera 1}^{rbase} H \cdot {}_{board 1}^{camera 1} H ,$$

wherein

$${}_{board 1}^{lbase} H$$

is the homogeneous transformation matrix of the coordinate system of the first positioning coordinate plate 6 in the coordinate system of the first robotic arm 81,

$${}_{camera 1}^{lbase} H$$

is the homogeneous transformation matrix of the coordinate system of the first optical locator 4 in the coordinate system of the first robotic arm 81,

$${}_{board 1}^{rbase} H$$

is the homogeneous transformation matrix of the coordinate system of the first positioning coordinate plate in the coordinate system of the first optical locator 4,

$${}_{camera 1}^{rbase} H$$

is the homogeneous transformation matrix of the coordinate system of the first positioning coordinate plate 6 in the coordinate system of the second robotic arm 82, and

$${}_{camera 1}^{rbase} H$$

is the homogeneous transformation matrix of the coordinate system of the first optical locator 4 in the coordinate system of the second robotic arm 82.

In addition, the homogeneous transformation matrix of the coordinate system of the first operation glove 2 in the coordinate system of the second positioning coordinate plate 7 and the homogeneous transformation matrix of the coordinate system of the second operation glove 3 in the coordinate system of the second positioning coordinate plate 7 are obtained by using the matrix calculation equations

$${}_{rglove}^{board 2} H = {}_{camera 1}^{board 2} H \cdot {}_{rglove}^{camera 1} H and$$

$${}_{lglove}^{board 2} H = {}_{camera 1}^{board 2} H \cdot {}_{camera 2}^{camera 1} H \cdot {}_{lglove}^{camera 2} H ,$$

where

$${}_{camera 1}^{board 2} H$$

is the homogeneous transformation matrix of the coordinate system of the first optical locator 4 in the coordinate system of the second positioning coordinate plate 7,

$${}_{rglove}^{camera 1} H$$

is the homogeneous transformation matrix of the coordinate system of the first operation glove 2 in the coordinate system of the first optical locator 4,

$${}_{camera 1}^{board 2} H$$

is the homogeneous transformation matrix of the coordinate system of the first optical locator 4 in the coordinate system of the second positioning coordinate plate 7,

$${}_{camera 2}^{camera 1} H$$

is the homogeneous transformation matrix of the coordinate system of the second optical locator 5 in the coordinate system of the first optical locator 4, and

$${}_{lglove}^{camera 2} H$$

is the homogeneous transformation matrix of the coordinate system of the second operation glove 3 in the coordinate system of the second optical locator 5.

The relative poses of the coordinate system of the first robotic hand 83 and the coordinate system of the second robotic hand of the dual arm and hand robot 8 relative to the coordinate system of the first positioning coordinate plate 6 are respectively equal to the relative poses of the coordinate system of the second operation glove 3 and the coordinate system of the first operation glove 2 relative to the coordinate system of the second positioning coordinate plate 7, that is,

$${}_{lhand}^{board 1} H = {}_{lglove}^{board 2} H and {}_{rhand}^{board 1} H = {}_{rglove}^{board 2} H ,$$

and after matrix calculation,

$${}_{lend}^{lbase} {H}_{aim} = {board 1}_{lbase}^{} \text{} H {\cdot }_{lhand}^{board 1} H {\cdot }_{lend}^{lhand} H$$

$$and$$

$${}_{rend}^{rbase} {H}_{aim} = {board 1}_{rbase}^{} H {\cdot }_{rhand}^{board 1} H {\cdot }_{rend}^{rhand} H ,$$

the homogeneous transformation matrix

$${lend}_{lbase}^{} {H}_{aim}$$

of the coordinate system of the end joint of the first robotic arm 81 in the coordinate system of the first robotic arm 81 and the homogeneous transformation matrix

$${rend}_{rbase}^{} {H}_{aim}$$

of the coordinate system of the end joint of the second robotic arm 82 in the coordinate system of the second robotic arm 82 under the tracking state are obtained, wherein

$${board 1}_{lbase}^{} H$$

is the homogeneous transformation matrix of the coordinate system of the first positioning coordinate plate 6 in the coordinate system of the first robotic arm 81,

$${}_{lhand}^{board 1} H$$

is the homogeneous transformation matrix of the coordinate system of the first robotic hand 83 in the coordinate system of the first positioning coordinate plate 6,

$$\text{} {}_{lend}^{lhand} H$$

is the homogeneous transformation matrix of the coordinate system of the end joint of the first robotic arm 81 in the coordinate system of the first robotic hand 83,

$${}_{board 1}^{rbase} \text{} H$$

is the homogeneous transformation matrix of the coordinate system of the first positioning coordinate plate 6 in the coordinate system of the second robotic arm 82,

$${}_{rhand}^{board 1} H$$

is the homogeneous transformation matrix of the coordinate system of the second robotic hand 84 in the coordinate system of the first positioning coordinate plate 6, and

$${}_{rend}^{rhand} H$$

is the homogeneous transformation matrix of the coordinate system of the end joint of the second robotic arm 82 in the coordinate system of the second robotic hand 84.

A movement control command is issued to the dual arm and hand robot 8 to achieve a real-time teleoperation task of the dual arm and hand robot 8 by the operation glove, and the spatial pose transformation relationships on which the control command is based are

$${}_{lend}^{lbase} {H}_{aim} {and}_{rend}^{rbase} \text{} {H}_{aim} ,$$

wherein

$${}_{lend}^{lbase} {H}_{aim}$$

is the homogeneous transformation matrix of the coordinate system of the end joint of the first robotic arm 81 in the coordinate system of the first robotic arm 81 under the tracking state, and

$${rend}_{rbase}^{} \text{} {H}_{aim}$$

is the homogeneous transformation matrix of the coordinate system of the end joint of the second robotic arm 82 in the coordinate system of the second robotic arm 82 under the tracking state.

The hand-eye calibration algorithm solving formulas are

$${}_{lend}^{lhand} H {=}_{camera 1}^{lhand} \text{} H \cdot \text{} {}_{lbase}^{camera 1} H \cdot \text{} {}_{lend}^{lbase} H$$

$$and$$

$${rend}_{rhand}^{} \text{} H {=}_{camera 1}^{rhand} \text{} H \cdot \text{} {}_{rbase}^{camera 1} H \cdot \text{} {}_{rend}^{rbase} H ,$$

wherein

$${}_{lend}^{lhand} H$$

is the homogeneous transformation matrix of the coordinate system of the end joint of the first robotic arm 81 in the coordinate system of the first robotic hand 83,

$${camera 1}_{lhand}^{} \text{} H$$

is the homogeneous transformation matrix of the coordinate system of the first optical locator 4 in the coordinate system of the first robotic hand 83,

$${}_{lbase}^{camera 1} H$$

is the homogeneous transformation matrix of the coordinate system of the first robotic arm 81 in the coordinate system of the first optical locator 4,

$${}_{lend}^{lbase} H$$

is the homogeneous transformation matrix of the coordinate system of the end joint of the first robotic arm 81 in the coordinate system of the first robotic arm 81,

$${}_{rend}^{rhand} H$$

is the homogeneous transformation matrix of the coordinate system of the end joint of the second robotic arm 82 in the coordinate system of the second robotic hand 84,

$${}_{camera 1}^{rhand} H$$

is the homogeneous transformation matrix of the coordinate system of the first optical locator 4 in the coordinate system of the second robotic hand 84,

$${}_{rbase}^{camera 1} H$$

is the homogeneous transformation matrix of the coordinate system of the second robotic arm 82 in the coordinate system of the first optical locator 4, and

$${}_{rend}^{rbase} H$$

is the homogeneous transformation matrix of the coordinate system of the end joint of the second robotic arm 82 in the coordinate system of the second robotic arm 82.

According to another aspect of the present disclosure, there is provided a real-time teleoperation system for a dual arm and hand robot 8 based on vision guidance, including a control system host 1, a first operation glove 2, a second operation glove 3, a first optical locator 4, a second optical locator 5, a first positioning coordinate plate 6, a second positioning coordinate plate 7, a first marker ball tool 21, a second marker ball tool 31, a third marker ball tool 61, a fourth marker ball tool 71, a fifth marker ball tool 9, and a dual arm and hand robot 8. The control system host 1 receives and processes finger pose information of the first operation glove 2 and the second operation glove 3 via bluetooth, connects with the dual arm and hand robot 8 via Ethernet, and issues control commands; the first operation glove 2 and the second operation glove 3 are both provided with sensors and are worn by an operator; the first operation glove 2 is provided with the first marker ball tool 21 on the back thereof, and the second operation glove 3 is provided with the second marker ball tool 31 on the back thereof, the first positioning coordinate plate 6 is provided with the third marker ball tool 61, and the second positioning coordinate plate 7 is provided with the fourth marker ball tool 71.

The first optical locator 4 captures a coordinate information of the first marker ball tool 21, the second optical locator 5 captures a coordinate information of the second marker ball tool 31, and the first optical locator 4 also captures pose information of the third marker ball tool 61, the fourth marker ball tool 71, and the fifth marker ball tool 9 simultaneously. The first optical locator 4 and the second optical locator 5 transmit all captured pose information and spatial coordinate data via the Ethernet to the control system host 1, the captured pose information and spatial coordinate data are processed uniformly by the control system host 1, and control commands are sent to the dual arm and hand robot 8; the dual arm and hand robot 8 is provided in one set, including a first robotic arm 81, a second robotic arm 82, a first robotic hand 83, and a second robotic hand 84; and the first robotic hand 83 is mounted on the first robotic arm 81, the second robotic hand 84 is mounted on the second robotic arm 82, both the first robotic arm 81 and the second robotic arm 82 are six-axis robotic arms, the fifth marker ball tool 9 includes a sixth marker ball tool 831 and a seventh marker ball tool 841, and the sixth marker ball tool 831 is fixed to the first robotic hand 83, and the seventh marker ball tool 841 is fixed to the second robotic hand 84.

Specifically, the control system host 1 of the present disclosure is used to process control signals. The first operation glove 2 and the second operation glove 3 may collect spatial pose and finger pose data. The first optical locator 4, the second optical locator 5, the first positioning coordinate plate 6, and the second positioning coordinate plate 7 may obtain the spatial pose information of the first operation glove 2, the second operation glove 3, and the dual arm and hand robot 8. The control system host 1 is used to receive and process the pose information of the first operation glove 2 and the second operation glove 3, and issue control commands to the dual arm and hand robot 8. The first operation glove 2 and the second operation glove 3 are worn by an operator 10 and may record the finger pose information. The first optical locator 4 and the second optical locator 5 are used to obtain hand pose information of the operator 10 wearing the first operation glove 2 and the second operation glove 3, and hand pose information of the dual arm and hand robot 8 during the movement process. The first positioning coordinate plate 6 and the second positioning coordinate plate 7 are used to assist in determining the relative pose of the hand of the dual arm and hand robot 8 and the hand of the first operation glove 2 and the second operation glove 3 with respect to the first positioning coordinate plate 6 and the second positioning coordinate plate 7. The dual arm and hand robot 8 is a controlled object of the entire teleoperation system and is used to perform corresponding actions according to the control commands issued by the control system host 1.

The backs of the first operation glove 2 and the second operation glove 3 are respectively fixed with the first marker ball tool 21 and the second marker ball tool 31, through which the first optical locator 4 and the second optical locator 5 may identify the spatial pose. The finger movement information of the gloves may be acquired by the sensors inside the gloves. The first positioning coordinate plate 6 and the second positioning coordinate plate 7 may also respectively fixed with the third marker ball tool 61 and the fourth marker ball tool 71, through which the first optical locator 4 and the second optical locator 5 may identify the spatial pose. The dual arm and hand robot 8 is configured in a set, consisting of the first robotic arm 81, the second robotic arm 82, the first robotic hand 83, and the second robotic hand 84. The back of the robotic hands are provided with the marker ball tools, through which the optical locators may identify the spatial pose. The first robotic hand 83 is installed on the first robotic arm 81, the second robotic hand 84 is installed on the second robotic arm 82, the sixth marker ball tool 831 is fixed on the first robotic hand 83, and the seventh marker ball tool 841 is fixed on the second robotic hand 84.

In the actual construction of the operation system, the dual arm and hand robot 8, the first optical locator 4, and the first positioning coordinate plate 6 are planned as the first experimental area, and the first experimental platform is constructed. The first optical locator 4 is placed not far from the front of the dual arm and hand robot 8, and the sixth marker ball tool 831 and the seventh marker ball tool 841 on the back of the hand are placed within the common viewing field of the first optical locator 4, and then, the first positioning coordinate plate 6 is placed not far from the front of the dual arm and hand robot 8, and the third marker ball tool 61 on the first positioning coordinate plate 6 is placed within the common viewing field of the first optical locator 4. The first optical locator 4 identifies the spatial coordinate information of the fifth marker ball tool 9 to obtain the pose information of the dual arm and hand robot 8 and transmits the data to the control system host 1 in a manner of Socket communication. The spatial coordinate information of the fifth marker ball tool 9 and the third marker ball tool 61 may be identified through the first optical locator 4, and after the hand-eye calibration algorithm and the spatial pose transformation, the relative pose relationship of the hand of the dual arm and hand robot 8 with respect to the first positioning coordinate plate 6 may be determined, and the calibration result is saved in the control system host 1 in the form of a text file.

The first operation glove 2, the second operation glove 3, the first optical locator 4, the second optical locator 5, and the second positioning coordinate plate 7 are configured as the second experimental area, and the second experimental platform is constructed. The first optical locator 4 in the first experimental area is moved to the second experimental area. The first optical locator 4 and the second optical locator 5 are placed not far from the front of the first operation glove 2 and the second operation glove 3, respectively. The first marker ball tool 21 and the second marker ball tool 31 are placed within the common viewing field of the first optical locator 4 and the second optical locator 5, respectively. The second positioning coordinate plate 7 is placed not far from the fronts of the first operation glove 2 and the second operation glove 3 and within the common viewing field of the first optical locator 4. After calibration of the first optical locator 4 and the second optical locator 5, the calibration result is saved in the control system host 1 in the form of a text file. The spatial coordinate information of the first operation glove 2, the second operation glove 3, and the second positioning coordinate plate 7 are identified through the first optical locator 4 and the second optical locator 5, and after the spatial pose transformation, the relative pose relationship of the first operation glove 2 and the second operation glove 3 with respect to the second positioning coordinate plate 7 is determined. The finger pose information of the first operation glove 2 and the second operation glove 3 is read by the finger pose sensors on them and the data is transmitted to the control system host 1 in a manner of Bluetooth communication. Finally, the finger pose data of the first operation glove 2 and the second operation glove 3 and the motion trajectory data relative to the second positioning coordinate plate 7 are transmitted to the control system host 1 and transformed into the pose transformation of the arms and the hands of the dual arm and hand robot 8 relative to the first positioning coordinate plate 6. The control system host 1 issues control commands via the Socket communication to control the first robotic hand 83 and the first robotic arm 81 as well as the second robotic hand 84 and the second robotic arm 82 of the dual arm and hand robot 8 to perform real-time following of the transformed motion trajectories, respectively.

The preferred embodiments of the present disclosure are provided and should not be construed as limiting the protection scope of the present disclosure. For those skilled in the art, it should be pointed out that several improvements and refinements may be made without departing from the principle of the present disclosure, and these improvements and refinements should also be regarded to be within the protection of the present disclosure.

What is claimed is:

1. A construction method for real-time teleoperation of a dual arm and hand robot based on vision guidance, wherein the method comprises following steps:
S1: setting up a first experimental platform: operating a dual arm and hand robot, a first optical locator, and a first positioning coordinate plate on the first experimental platform;
S2: acquiring a pose information of the dual arm and hand robot: identifying spatial coordinate information of a sixth marker ball tool and a seventh marker ball tool on a back of a hand of the dual arm and hand robot by the first optical locator to obtain the spatial pose information of the dual arm and hand robot, and obtaining a homogeneous transformation matrix
$${}_{camera 1}^{lhand} H$$
of a coordinate system of the first optical locator in a coordinate system of a first robotic hand, a homogeneous transformation matrix
$${}_{camera 1}^{rhand} H$$
of the coordinate system of the first optical locator in a coordinate system of a second robotic hand, and a homogeneous transformation matrix
$${}_{camera 1}^{board 1} H$$
of the coordinate system of the first optical locator in a coordinate system of the first positioning coordinate plate, and transmitting data to a control system host;
S3: acquiring a homogeneous transformation matrix of an end joint of the dual arm and hand robot: obtaining a homogeneous transformation matrix
$${}_{lend}^{lbase} H$$
of a coordinate system of the end joint of a first robotic arm in the coordinate system of the first robotic arm, and a homogeneous transformation matrix
$${}_{rend}^{rbase} H$$
of a coordinate system of the end joint of a second robotic arm in the coordinate system of the second robotic arm through a robotic arm interface function;
S4: transforming a first coordinate system: after hand-eye calibration algorithm and spatial pose transformation, obtaining a transformation matrix
$${}_{board 1}^{lbase} H$$
of the coordinate system of the first positioning coordinate plate in the coordinate system of the first robotic arm and a transformation matrix
$${}_{board 1}^{rbase} H$$
of the coordinate system of the first positioning coordinate plate in the coordinate system of the second robotic arm, and saving a calibration result in the control system host in a form of a text file;
S5: setting up a second experimental platform: operating a first operation glove, a second operation glove, a first optical locator, a second optical locator, and a second positioning coordinate plate on the second experimental platform;
S6: performing calibration by a plurality of cameras: placing a calibration tool provided with marker ball tools within a common viewing field of the first optical locator and the second optical locator, and determining relative pose relationship
$${}_{camera 2}^{camera 1} H$$
of the first optical locator and the second optical locator by using the spatial pose transformation, and saving the calibration result in the control system host in the form of a text file;
S7: transforming a second coordinate system: identifying a homogeneous transformation matrix
$${}_{rglove}^{camera 1} H$$
of a coordinate system of the first operation glove in the coordinate system of the first optical locator and a homogeneous transformation matrix
$${}_{board 2}^{camera 1} H$$
of a coordinate system of the second positioning coordinate plate in the coordinate system of the first optical locator through the first optical locator, and identifying a homogeneous transformation matrix
$${}_{lglove}^{camera 2} H$$
of a coordinate system of the second operation glove in the coordinate system of the second optical locator through the second optical locator, and retrieving a relative pose calibration result
$${}_{camera 2}^{camera 1} H$$
of the first optical locator and the second optical locators in the step S6, and after matrix calculation, obtaining a homogeneous transformation matrix
$${}_{rglove}^{board 2} H$$
of the coordinate system of the first operation glove in the coordinate system of the second positioning coordinate plate and a homogeneous transformation matrix
$${}_{lglove}^{board 2} H$$
of the coordinate system of the second operation glove in the coordinate system of the second positioning coordinate plate;
S8: when in a real-time teleoperation process, the homogeneous transformation matrix
$${}_{lglove}^{board 2} H$$
of the coordinate system of the second operation glove relative to the coordinate system of the second positioning coordinate plate and the homogeneous transformation matrix
$${}_{rglove}^{board 2} H$$
of the coordinate system of the first operation glove relative to the coordinate system of the second positioning coordinate plate are respectively equal to the homogeneous transformation matrix
$${}_{lhand}^{board 1} H$$
of the coordinate system of the first robotic hand relative to the coordinate system of the first positioning coordinate plate and the homogeneous transformation matrix
$${}_{rhand}^{board 1} H$$
of the coordinate system of the second robotic hand relative to the coordinate system of the first positioning coordinate plate, and after matrix calculation, obtaining a homogeneous transformation matrix
$${}_{lend}^{lbase} {H}_{aim}$$
of the coordinate system of the end joint of the first robotic arm in the coordinate system of the first robotic arm and a homogeneous transformation matrix
$${}_{rend}^{rbase} {H}_{aim}$$
of the coordinate system of the end joint of the second robotic arm in the coordinate system of the second robotic arm under a tracking state;
S9: transmitting a finger pose data to the control system host after the finger pose data is read by a finger pose sensor in the first operation glove and the second operation glove;
S10: transmitting motion trajectory data of the first operation glove and the second operation glove relative to the second positioning coordinate plate collected by the first optical locator and the second optical locator to the control system host, and after being transformed into the pose transformation of the hands of the dual arm and hand robot relative to the first positioning coordinate plate, issuing control commands by the control system host to control the first robotic hand and the first robotic arm and the second robotic hand and the second robotic arm of the dual arm and hand robot to respectively perform real-time following of the transformed motion trajectory.

2. The construction method for real-time teleoperation of a dual arm and hand robot based on vision guidance according to claim 1, wherein spatial pose transformation equations for determining the relative pose relationship between the first robotic arm and the second robotic arm of the dual arm and hand robot and the first positioning coordinate plate through the first optical locator are
$${}_{board 1}^{lbase} H = {}_{camera 1}^{lbase} H \cdot {}_{board 1}^{camera 1} H and {}_{board 1}^{rbase} H = {}_{camera 1}^{rbase} H \cdot {}_{board 1}^{camera 1} H ,$$
wherein
$${}_{board 1}^{lbase} H$$
is the homogeneous transformation matrix of the coordinate system of the first positioning coordinate plate in the coordinate system of the first robotic arm,
$${}_{camera 1}^{lbase} H$$
is the homogeneous transformation matrix of the coordinate system of the first optical locator in the coordinate system of the first robotic arm,
$${}_{board 1}^{rbase} H$$
is the homogeneous transformation matrix of the coordinate system of the first positioning coordinate plate in the coordinate system of the first optical locator,
$${}_{camera 1}^{rbase} H$$
is the homogeneous transformation matrix of the coordinate system of the first positioning coordinate plate in the coordinate system of the second robotic arm, and
$${}_{camera 1}^{rbase} H$$
is the homogeneous transformation matrix of the coordinate system of the first optical locator in the coordinate system of the second robotic arm.

3. The construction method for real-time teleoperation of a dual arm and hand robot based on vision guidance according to claim 1, wherein the homogeneous transformation matrix of the coordinate system of the first operation glove in the coordinate system of the second positioning coordinate plate and the homogeneous transformation matrix of the coordinate system of the second operation glove in the coordinate system of the second positioning coordinate plate are obtained by using the matrix calculation equations
$${}_{rglove}^{board 2} H = {}_{camera 1}^{board 2} H \cdot {}_{rglove}^{camera 1} H and {}_{lglove}^{board 2} H = {}_{camera 1}^{board 2} H \cdot {}_{camera 2}^{camera 1} H \cdot {}_{lglove}^{camera 2} H ,$$
where
$${}_{camera 1}^{board 2} H$$
is the homogeneous transformation matrix of the coordinate system of the first optical locator in the coordinate system of the second positioning coordinate plate,
$${}_{rglove}^{camera 1} H$$
is the homogeneous transformation matrix of the coordinate system of the first operation glove in the coordinate system of the first optical locator,
$${}_{camera 1}^{board 2} H$$
is the homogeneous transformation matrix of the coordinate system of the first optical locator in the coordinate system of the second positioning coordinate plate,
$${}_{camera 2}^{camera 1} H$$
is the homogeneous transformation matrix of the coordinate system of the second optical locator in the coordinate system of the first optical locator, and
$${}_{lglove}^{board 2} H$$
is the homogeneous transformation matrix of the coordinate system of the second operation glove in the coordinate system of the second optical locator.

4. The construction method for real-time teleoperation of a dual arm and hand robot based on vision guidance according to claim 1, wherein the relative poses of the coordinate system of the first robotic hand and the coordinate system of the second robotic hand of the dual arm and hand robot relative to the coordinate system of the first positioning coordinate plate are respectively equal to the relative poses of the coordinate system of the second operation glove and the coordinate system of the first operation glove relative to the coordinate system of the second positioning coordinate plate, that is,
$${}_{lhand}^{board 1} H = {}_{lglove}^{board 2} H and {}_{rhand}^{board 1} H = {}_{rglove}^{board 2} H ,$$
and after matrix calculation,
$${}_{lend}^{lbase} {H}_{aim} = {}_{board 1}^{lbase} H \cdot {}_{lhand}^{board 1} H \cdot {}_{lend}^{lhand} H and {}_{rend}^{rbase} {H}_{aim} = {}_{board 1}^{rbase} H \cdot {}_{rhand}^{board 1} H \cdot {}_{rend}^{rhand} H ,$$
the homogeneous transformation matrix
$${}_{lend}^{lbase} {H}_{aim}$$
of the coordinate system of the end joint of the first robotic arm in the coordinate system of the first robotic arm and the homogeneous transformation matrix
$${}_{rend}^{rbase} {H}_{aim}$$
of the coordinate system of the end joint of the second robotic arm in the coordinate system of the second robotic arm under the tracking state are obtained, wherein
$${}_{board 1}^{lbase} H$$
is the homogeneous transformation matrix of the coordinate system of the first positioning coordinate plate in the coordinate system of the first robotic arm,
$${}_{lhand}^{board 1} H$$
is the homogeneous transformation matrix of the coordinate system of the first robotic hand in the coordinate system of the first positioning coordinate plate,
$${}_{lend}^{lhand} H$$
is the homogeneous transformation matrix of the coordinate system of the end joint of the first robotic arm in the coordinate system of the first robotic hand,
$${}_{board 1}^{rbase} H$$
is the homogeneous transformation matrix of the coordinate system of the first positioning coordinate plate in the coordinate system of the second robotic arm,
$${}_{rhand}^{board 1} H$$
is the homogeneous transformation matrix of the coordinate system of the second robotic hand in the coordinate system of the first positioning coordinate plate, and
$${}_{rend}^{rhand} H$$
is the homogeneous transformation matrix of the coordinate system of the end joint of the second robotic arm in the coordinate system of the second robotic hand.

5. The construction method for real-time teleoperation of a dual arm and hand robot based on vision guidance according to claim 1, wherein a movement control command is issued to the dual arm and hand robot to achieve a real-time teleoperation task of the dual arm and hand robot by the operation glove, and the spatial pose transformation relationships on which the control command is based are
$${}_{lend}^{lbase} {H}_{aim} and {}_{rend}^{rbase} {H}_{aim} ,$$
wherein
$${}_{lend}^{lbase} {H}_{aim}$$
is the homogeneous transformation matrix of the coordinate system of the end joint of the first robotic arm in the coordinate system of the first robotic arm under the tracking state, and
$${}_{rend}^{rbase} {H}_{aim}$$
is the homogeneous transformation matrix of the coordinate system of the end joint of the second robotic arm in the coordinate system of the second robotic arm under the tracking state.

6. The construction method for real-time teleoperation of a dual arm and hand robot based on vision guidance according to claim 1, wherein the hand-eye calibration algorithm solving formulas are
$${}_{lend}^{lhand} H = {}_{camera 1}^{lhand} H \cdot {}_{lbase}^{camera 1} H \cdot {}_{lend}^{lbase} H$$
$$and$$
$${}_{rend}^{rhand} H = {}_{camera 1}^{rhand} H \cdot {}_{rbase}^{camera 1} H \cdot {}_{rend}^{rbase} H ,$$
wherein
$${}_{lend}^{lhand} H$$
is the homogeneous transformation matrix of the coordinate system of the end joint of the first robotic arm in the coordinate system of the first robotic hand,
$${}_{camera 1}^{lhand} H$$
is the homogeneous transformation matrix of the coordinate system of the first optical locator in the coordinate system of the first robotic hand,
$${}_{lbase}^{camera 1} H$$
is the homogeneous transformation matrix of the coordinate system of the first robotic arm in the coordinate system of the first optical locator,
$${}_{lend}^{lbase} H$$
is the homogeneous transformation matrix of the coordinate system of the end joint of the first robotic arm in the coordinate system of the first robotic arm,
$${}_{rend}^{rhand} H$$
is the homogeneous transformation matrix of the coordinate system of the end joint of the second robotic arm in the coordinate system of the second robotic hand,
$${}_{camera 1}^{rhand} H$$
is the homogeneous transformation matrix of the coordinate system of the first optical locator in the coordinate system of the second robotic hand,
$${}_{rbase}^{camera 1} H$$
is the homogeneous transformation matrix of the coordinate system of the second robotic arm in the coordinate system of the first optical locator, and
$${}_{rend}^{rbase} H$$
is the homogeneous transformation matrix of the coordinate system of the end joint of the second robotic arm in the coordinate system of the second robotic arm.

7. The construction method for real-time teleoperation of a dual arm and hand robot based on vision guidance according to claim 1, wherein the step S1 comprises following sub-steps:
S11: placing the first optical locator in front of the dual arm and hand robot;
S12: placing the sixth marker ball tool and the seventh marker ball tool respectively in fixing devices on the backs of the hands of the dual arm and hand robot, and placing them within the common viewing field of the first optical locator;
S13: placing the first positioning coordinate plate in front of the dual arm and hand robot and providing a third marker ball tool on the first positioning coordinate plate within the common viewing field of the first optical locator.

8. The construction method for real-time teleoperation of a dual arm and hand robot based on vision guidance according to claim 1, wherein the step S5 includes following sub-steps:
S51: moving the first optical locator from the first experimental area to the second experimental area, and placing the first optical locator and the second optical locator in front of the first operation glove and the second operation glove, respectively;
S52: placing the first marker ball tool and the second marker ball tool in the fixing devices on the backs of the first operation glove and the second operation glove, respectively, and placing them within the common viewing field of the first optical locator and the second optical locator, respectively;
S53: placing the second positioning coordinate plate in front of the first operation glove and the second operation glove, within the common viewing field of the first optical locator.

9. A real-time teleoperation system for a dual arm and hand robot based on vision guidance, comprising a control system host, a first operation glove, a second operation glove, a first optical locator, a second optical locator, a first positioning coordinate plate, a second positioning coordinate plate, a first marker ball tool, a second marker ball tool, a third marker ball tool, a fourth marker ball tool, a fifth marker ball tool, and a dual arm and hand robot;
wherein the control system host receives and processes finger pose information of the first operation glove and the second operation glove, connects with the dual arm and hand robot via Ethernet, and issues control commands; the first operation glove and the second operation glove are both provided with sensors and are worn by an operator; the first operation glove is provided with the first marker ball tool on the back thereof, and the second operation glove is provided with the second marker ball tool on the back thereof, the first positioning coordinate plate is provided with the third marker ball tool, and the second positioning coordinate plate is provided with the fourth marker ball tool;
the first optical locator captures a coordinate information of the first marker ball tool, the second optical locator captures a coordinate information of the second marker ball tool, and the first optical locator also captures pose information of the third marker ball tool, the fourth marker ball tool, and the fifth marker ball tool simultaneously;
the first optical locator and the second optical locator transmit all captured pose information and spatial coordinate data via the Ethernet to the control system host, the captured pose information and spatial coordinate data are processed uniformly by the control system host, and control commands are sent to the dual arm and hand robot; the dual arm and hand robot includes a first robotic arm, a second robotic arm, a first robotic hand, and a second robotic hand; and the first robotic hand is mounted on the first robotic arm, the second robotic hand is mounted on the second robotic arm, both the first robotic arm and the second robotic arm are six-axis robotic arms, the fifth marker ball tool includes a sixth marker ball tool and a seventh marker ball tool, and the sixth marker ball tool is fixed to the first robotic hand, and the seventh marker ball tool is fixed to the second robotic hand.
